(19) United States
(12) Patent Application Publication
(10) Pub. No.: US 2026/0256155 A1
(43) Pub. Date: Sep. 3, 2026

(54) PULSED ELECTRIC FIELD PROCESSOR

(71) Applicant: Mitsubishi Electric Corporation, Tokyo (JP)

(72) Inventors: Takahiro INOUE, Tokyo (JP); Shingo TSUDA, Tokyo (JP); Kiriu SATO, Tokyo (JP)

(73) Assignee: Mitsubishi Electric Corporation, Tokyo (JP)

(21) Appl. No.: 18/871,304

(22) PCT Filed: Jun. 15, 2022
(86) PCT No.: PCT/JP2022/023957

§ 371 Date: Dec. 3, 2024

(51) Int. Cl. A23B 2/05; A23B 2/00; A23B 11/16; A23B 70/50

(52) U.S. Cl. CPC A23B 2/05; A23B 2/001; A23B 11/16; A23B 70/50

(57) ABSTRACT

A pulsed electric field processor includes: a first processor that performs first processing on an object to be processed, the first processing being pulsed electric field processing, the object to be processed being in liquid form; a first pipe through which the object to be processed having passed through the first processor passes; a second processor that performs second processing on the object to be processed, the second processing including the pulsed electric field processing, the object to be processed having passed through the first pipe flowing into the second processor; a second pipe through which the object to be processed having passed through the second processor passes; and a third processor that performs third processing on the object to be processed, the third processing including the pulsed electric field processing, the object to be processed having passed through the second pipe passes through the third processor.

### FIELD

The present disclosure relates to a pulsed electric field processor that generates a pulsed electric field.

### BACKGROUND

A pulsed electric field processing technique can be cited as a technique that enables food or beverages to be processed at a lower temperature than in heat treatment.

Patent Literature 1 discloses a sterilization device for sterilizing a liquid food material while the liquid food material is flowing downstream. Patent Literature 1 discloses that the temperature of a liquid food material is raised in a first temperature-rise region, an electric field is applied to the liquid food material kept at the raised temperature in an electric heating region, the temperature of the liquid food material is further raised in a second temperature-rise region, the raised temperature is maintained in a heat-retaining region, and the liquid food material is cooled in a cooling region and returned to normal temperature.

### CITATION LIST

### Patent Literature

Patent Literature 1: Japanese Patent Application Laid-open No. 2010-183973

### SUMMARY OF INVENTION

### Problem to be Solved by the Invention

In Patent Literature 1, two processing units of the temperature-rise region and the electric heating region are provided. A heat insulating material is provided in the temperature-rise region, which is one of the processing units, and heat radiation adjustment is performed by the processing unit. Therefore, the technique disclosed in Patent Literature 1 has a problem in that the processing unit is structurally restricted to cause the device to increase in size and become complicated.

The present disclosure has been made in view of the above, and an object of the present disclosure is to obtain a pulsed electric field processor that has a simple structure and can be downsized.

### Means to Solve the Problem

To solve the above problems and achieve the object, a pulsed electric field processor according to the present disclosure includes: a first processor configured to perform first processing on an object to be processed, the first processing being pulsed electric field processing, the object to be processed being in liquid form; a first pipe through which the object to be processed having passed through the first processor passes; a second processor configured to perform second processing on the object to be processed, the second processing including the pulsed electric field processing, the object to be processed having passed through the first pipe flows into the second processor; a second pipe through which the object to be processed having passed through the second processor passes; and a third processor configured to perform third processing on the object to be processed, the third processing including the pulsed electric field processing, the object to be processed having passed through the second pipe passes through the third processor. Radiation performance of the second pipe is higher than radiation performance of the first pipe.

### Effects of the Invention

The pulsed electric field processor according to the present disclosure has the effect of enabling downsizing with a simple structure.

### BRIEF DESCRIPTION OF DRAWINGS

FIG. 1 is a schematic diagram illustrating an exemplary configuration of a pulsed electric field processor according to a first embodiment.

FIG. 2 is a cross-sectional view of a first processor of the pulsed electric field processor according to the first embodiment, which illustrates an exemplary configuration of the first processor.

FIG. 3 is a cross-sectional view of the first processor of the pulsed electric field processor according to the first embodiment, which illustrates another exemplary configuration of the first processor.

FIG. 4 is a circuit diagram illustrating an exemplary configuration of a pulsed power supply of the pulsed electric field processor according to the first embodiment.

FIG. 5 is a diagram showing an example of temperature distribution of an object to be processed by the pulsed electric field processor according to the first embodiment.

FIG. 6 is a cross-sectional view of the pulsed electric field processor according to the first embodiment, which illustrates the exemplary configuration of the pulsed electric field processor.

FIG. 7 is a cross-sectional view of the pulsed electric field processor according to the first embodiment, which illustrates another exemplary configuration of the pulsed electric field processor.

FIG. 8 is a schematic diagram illustrating still another exemplary configuration of the pulsed electric field according to the first embodiment.

FIG. 9 is a schematic diagram illustrating yet another exemplary configuration of the pulsed electric field processor according to the first embodiment.

FIG. 10 is a cross-sectional view of a pulsed electric field processor according to a second embodiment, which illustrates an exemplary configuration of the pulsed electric field processor.

FIG. 11 is a cross-sectional view of the pulsed electric field processor according to the second embodiment, which illustrates another exemplary configuration of the pulsed electric field processor.

### DESCRIPTION OF EMBODIMENTS

Hereinafter, pulsed electric field processors according to embodiments will be described in detail with reference to the drawings.

### First Embodiment

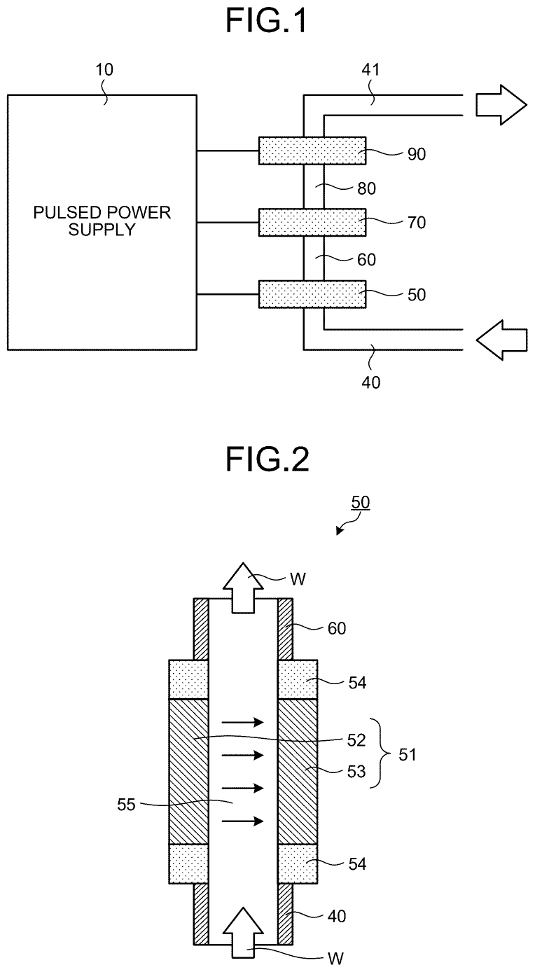

FIG. 1 is a schematic diagram illustrating an exemplary configuration of a pulsed electric field processor according to a first embodiment. The pulsed electric field processor includes: a pulsed power supply 10; an upstream pipe 40; a first processor 50; a first pipe 60; a second processor 70; a second pipe 80; a third processor 90; and a downstream pipe 41. The pulsed electric field processor performs processing including sterilization on an object to be processed. The pulsed power supply 10 outputs a pulse voltage of 1 kV or more with a pulse width of 100 microseconds or less. The object to be processed in liquid form, such as fruit juice or milk, flows through the upstream pipe 40, the first processor 50, the first pipe 60, the second processor 70, the second pipe 80, the third processor 90, and the downstream pipe 41 in this order. Each of the first processor 50, the second processor 70, and the third processor 90 is electrically connected to the pulsed power supply 10, and has a function of repeatedly applying a pulsed electric field to the object to be processed flowing inside the processor, based on the pulse voltage output from the pulsed power supply 10.

The first processor 50 performs, on the object to be processed, first processing that is pulsed electric field processing. The object to be processed having passed through the first processor 50 passes through the first pipe 60. The object to be processed having passed through the first pipe 60 flows in the second processor 70, which performs second processing including pulsed electric field processing on the object to be processed. The object to be processed having passed through the second processor 70 passes through the second pipe 80. The object to be processed having passed through the second pipe 80 passes through the third processor 90, which performs third processing including pulsed electric field processing on the object to be processed.

FIG. 2 is a cross-sectional view of the first processor 50 of the pulsed electric field processor according to the first embodiment, which illustrates an exemplary configuration of the first processor 50. The first processor 50 includes an electrode 51, insulating materials 54, and a processing chamber 55. The electrode 51 includes a high-voltage electrode 52 and a low-voltage electrode 53 paired with each other. A pulse voltage is applied to the high-voltage electrode 52. The low-voltage electrode 53 is maintained at the ground potential.

Titanium, platinum, stainless steel, or the like is used as the material of the electrode 51 so as to suppress wear of the electrode 51 due to pulse voltage. The high-voltage electrode 52 and the low-voltage electrode 53 have a flat-plate shape, and are disposed in such a way as to face each other with the object to be processed interposed therebetween. That is, the high-voltage electrode 52 and the low-voltage electrode 53 are disposed in such a way as to generate an electric field in a direction substantially perpendicular to a flow direction W of the object to be processed.

The processing chamber 55 in the first processor 50 is a space in which an electric field is generated by the electrode 51 and through which the object to be processed passes. Therefore, when the high-voltage electrode 52 and the low-voltage electrode 53 have a flat-plate shape and are disposed in such a way as to face each other, the processing chamber 55 has a rectangular parallelepiped shape. The high-voltage electrode 52 is connected to the upstream pipe 40 and the first pipe 60, which are made of pipe-shaped metal, via the insulating materials 54 so as to achieve electric insulation. The low-voltage electrode 53 may be connected to the upstream pipe 40 and the first pipe 60 via the insulating materials 54, or may be provided integrally with the upstream pipe 40 and the first pipe 60 without involving the insulating materials 54. The former case has an effect of reducing electric noise generated by the pulse voltage. Meanwhile, the latter case is advantageous in that the first processor 50 can be downsized. When a resin material containing fluorine or ceramics are used as the material of the insulating materials 54, the insulating materials 54 have high heat resistance and voltage endurance.

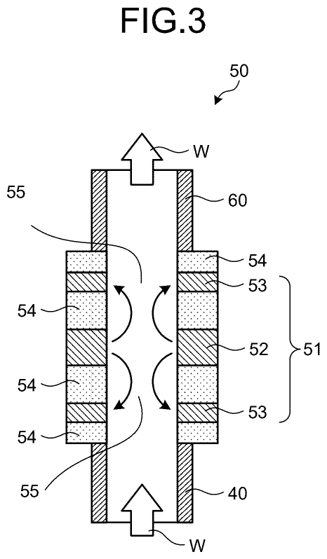

FIG. 3 is a cross-sectional view of the first processor 50 of the pulsed electric field processor according to the first embodiment, which illustrates another exemplary configuration of the first processor 50. In FIG. 3, the electrode 51 including the high-voltage electrode 52 and the low-voltage electrode 53 has a ring-shaped structure in which the flow direction W of the object to be processed serves as an axis. The upstream pipe 40, the insulating material 54, the low-voltage electrode 53, the insulating material 54, the high-voltage electrode 52, the insulating material 54, the low-voltage electrode 53, the insulating material 54, and the first pipe 60 are disposed in this order from the upstream side of the object to be processed. An electric field is generated in a direction substantially along the flow direction W of the object to be processed. Therefore, when all the high-voltage electrode 52, the low-voltage electrodes 53, and the insulating materials 54 have a ring-shaped structure with the same inner diameter, the processing chamber 55 has a columnar shape or a ring shape. In addition, since the low-voltage electrode 53 is disposed at two locations in such a way as to sandwich the high-voltage electrode 52 with respect to the flow direction W of the object to be processed, a path of current flowing from the high-voltage electrode 52 to the low-voltage electrode 53 is divided into two. The insulating material 54 between the low-voltage electrode 53 and the upstream pipe 40 and the insulating material 54 between the low-voltage electrode 53 and the first pipe 60 do not necessarily need to be provided. When the insulating materials 54 are provided, the effect of reducing electric noise is achieved. Providing no insulating materials 54 is advantageous in that downsizing can be achieved.

When the high-voltage electrode 52 and the low-voltage electrode 53 are disposed in such a way as to face each other as illustrated in FIG. 2, an electric field can be generated in the processing chamber 55 such that the generated electric field is spatially uniform. Thus, it is possible to achieve the effect of reducing unevenness of processing. When the high-voltage electrode 52 and the low-voltage electrodes 53 are disposed along the flow direction W of the object to be processed as illustrated in FIG. 3, the processing chamber 55 can be formed in a cylindrical shape, and the object to be processed can flow from the upstream pipe 40 to the first pipe 60 smoothly with low pressure loss.

The second processor 70 and the third processor 90 have the same configuration as that of the first processor 50 illustrated in FIG. 2 or 3, and redundant description will be omitted.

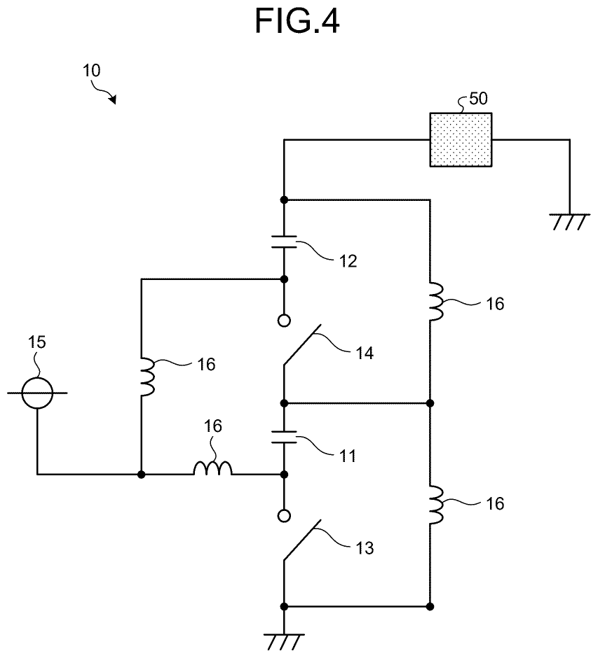

FIG. 4 is a circuit diagram illustrating an exemplary configuration of the pulsed power supply 10 of the pulsed electric field processor according to the first embodiment. FIG. 4 illustrates a circuit configuration for applying a pulse voltage to the first processor 50.

Circuits for applying a pulse voltage to the second processor 70 and the third processor 90 also have the same circuit configuration as that illustrated in FIG. 4. In the pulsed power supply 10, a switch 13, a capacitor 11, a switch 14, and a capacitor 12 are connected in series in this order from the ground side. The high-voltage electrode 52 of the first processor 50 is connected to the capacitor 12 by a cable or the like. In the capacitor 11, a terminal located closer to the switch 13 is a charging-side terminal, and a terminal located closer to the switch 14 is a ground-side terminal. Furthermore, in the capacitor 12, a terminal located closer to the switch 14 is a charging-side terminal, and a terminal located closer to the high-voltage electrode 52 is a ground-side terminal.

A direct-current power supply 15 generates a direct-current voltage for charging the capacitor 11 and the capacitor 12. The direct-current power supply 15 is connected to each of the charging-side terminals of the capacitor 11 and the capacitor 12 via at least one current limiter 16. In addition, at least one current limiter 16 is also provided between the respective charging-side terminals of the capacitor 11 and the capacitor 12. The ground-side terminals of the capacitor 11 and the capacitor 12 are each similarly grounded via at least one current limiter 16, and at least one current limiter 16 is provided between the ground-side terminals of the capacitor 11 and the capacitor 12.

The pulsed power supply 10 outputs a pulse voltage in two steps including a charging step and a discharging step. In the charging step, the capacitor 11 and the capacitor 12 are charged by the direct-current power supply 15. In the discharging step, the switch 13 and the switch 14 are turned on almost simultaneously, so that charging voltages of the capacitor 11 and the capacitor 12 are superimposed and output. After the superimposed charging voltage is output, the switch 13 and the switch 14 are turned off to end the discharging step. That is, a period in which the switches 13 and 14 are on is the period of the discharging step, and corresponds to a pulse width of a pulse voltage to be output from the pulsed power supply 10. The pulse voltage is a voltage to be output from the pulsed power supply 10 to the high-voltage electrode 52 in the discharging step, and a pulse current is a current flowing through the processing chamber 55 according to the pulse voltage.

A semiconductor switch such as a metal oxide semiconductor field effect transistor (MOSFET) or an insulated gate bipolar transistor (IGBT) is used as the switch 13 and the switch 14. Furthermore, a resistor or a reactor is used as the current limiter 16. Using a resistor is advantageous in that the capacitor 11 and the capacitor 12 can be charged with a stable voltage. Meanwhile, when a reactor is used, power consumption can be reduced.

The two capacitors and the two switches are used in the exemplary configuration of the pulsed power supply 10 illustrated in FIG. 4. Meanwhile, three or more capacitors and three or more switches may be used with a similar configuration. Increase of the numbers of capacitors and switches is advantageous in that a higher pulse voltage can be obtained.

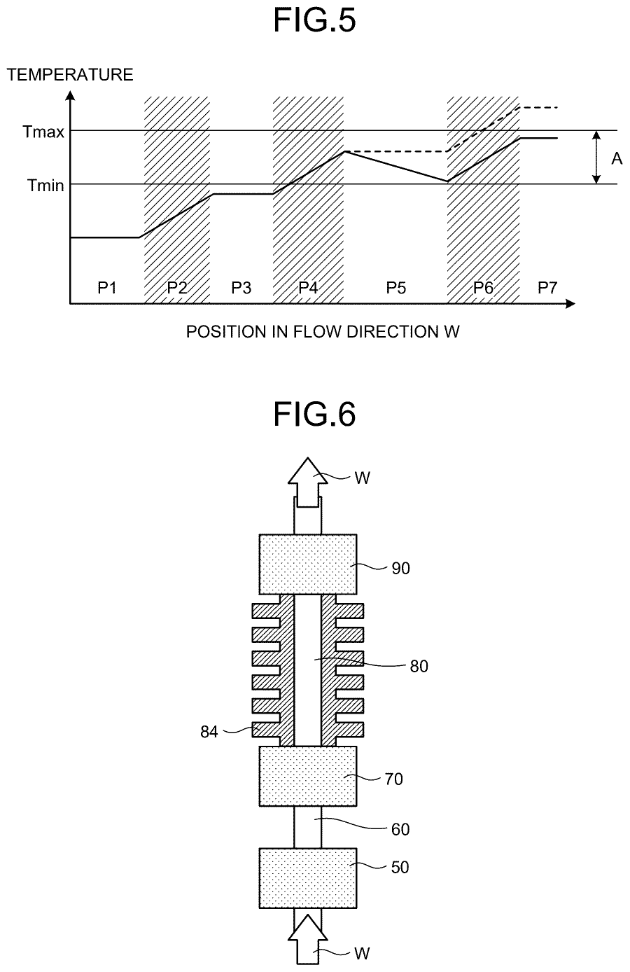

FIG. 5 is a diagram showing an example of temperature distribution of the object to be processed by the pulsed electric field processor according to the first embodiment. The horizontal axis in FIG. 5 represents the position of the object to be processed in the flow direction W, and the vertical axis in FIG. 5 represents the temperature of the object to be processed. FIG. 5 illustrates change in the temperature of the object to be processed in a path from the upstream pipe 40 to the downstream pipe 41. On the horizontal axis: P1 denotes an area corresponding to the upstream pipe 40; P2 denotes an area corresponding to the first processor 50; P3 denotes an area corresponding to the first pipe 60; P4 denotes an area corresponding to the second processor 70; P5 denotes an area corresponding to the second pipe 80; P6 denotes an area corresponding to the third processor 90; and P7 denotes an area corresponding to the downstream pipe 41.

In the area P2 corresponding to the first processor 50, the area P4 corresponding to the second processor 70, and the area P6 corresponding to the third processor 90, the temperature of the object to be processed increases according to energy supplied from the pulsed power supply 10. In the area P3 corresponding to the first pipe 60 and the area P5 corresponding to the second pipe 80, the temperature of the object to be processed varies according to each heat radiation amount. In FIG. 5, variations in the temperature of the object to be processed are indicated by a solid line and a broken line in the areas P5 to P7.

In the pulsed electric field processing, when temperature is too high, flavor is deteriorated and nutritional components are reduced, and when temperature is too low, treatment effect typified by sterilization is reduced. Therefore, it is desirable that an appropriate temperature range “A” between an appropriate upper limit value Tmax and an appropriate lower limit value Tmin for performing the pulsed electric field processing be provided such that the appropriate temperature range “A” is maintained for as long a distance as possible between the first processor 50, where a first process is performed, and the third processor 90, where a final process is performed. Since the appropriate temperature range “A” is higher than the temperature of the object to be processed in the area P1 corresponding to the upstream pipe 40, it is preferable not to suppress a temperature rise on the upstream side and it is preferable to suppress a temperature rise on the downstream side between the first processor 50 and the third processor 90. In addition, adoption of the structure of heat radiation adjustment in the first processor 50, the second processor 70, and the third processor 90 has a problem in that each processor is structurally restricted to cause the apparatus to increase in size and become complicated. Therefore, the first embodiment adopts a structure in which performance in radiation to the outside is higher in the second pipe 80 than in the first pipe 60.

For example, the radiation performance of the first pipe 60 can be expressed by the inverse of the sum of thermal resistance values of a path from the object to be processed passing through the inside of the first pipe 60 to the outside of the first pipe 60. Thus, the radiation performance is higher as the inverse of the sum of the thermal resistance values is larger. Therefore, it is possible to make the radiation performance of the second pipe 80 higher than that of the first pipe 60 by adopting: a first method of making the wall thickness of the second pipe 80 smaller than the wall thickness of the first pipe 60; a second method of making the thermal conductivity of a material included in the second pipe 80 higher than the thermal conductivity of a material included in the first pipe 60; or a third method of making an external contact area which is the heat radiation area of the second pipe 80 larger than an external contact area which is the heat radiation area of the first pipe 60. Note that, in the case of air cooling, the outside of the first pipe 60 and the second pipe 80 refers to, for example, ambient air around the first pipe 60 and the second pipe 80.

FIG. 6 is a cross-sectional view of the pulsed electric field processor according to the first embodiment, which illustrates the exemplary configuration of the pulsed electric field processor. In order to make the radiation performance of the second pipe 80 higher than the radiation performance of the first pipe 60, the length of the second pipe 80 is made longer than the length of the first pipe 60, and radiating fin 84 is provided on the second pipe 80. By providing the radiating fin 84, it is possible to enhance radiation performance per unit distance in a path in which the object to be processed passes through the second pipe 80. Therefore, even when the second pipe 80 and the first pipe 60 have the same length, the second pipe 80 can achieve higher radiation performance. Alternatively, the length of the second pipe 80 may be made longer than the length of the first pipe 60, as illustrated in FIG. 6, such that the effect of improving radiation performance per unit distance by means of the radiating fin 84 can be superimposed on the effect of improving the radiation performance by increasing the length of the second pipe 80. In any case, the radiation performance is made higher in a section from the inlet to the outlet of the second pipe 80 than in a section from the inlet to the outlet of the first pipe 60.

Specifically, the radiating fin 84 is an uneven metal body provided at a boundary surface between the second pipe 80 and the outside so as to increase the area of the boundary surface. The radiating fin 84 is provided such that smaller protrusions and recesses are provided or no protrusions or recesses are provided in the vicinity of the second processor 70 and the third processor 90 corresponding to both ends, while larger protrusions and recesses are provided in the vicinity of the middle. With such a structure, it is possible to reduce a risk of a discharge short circuit between: the radiating fin 84 which is the ground potential; and the second processor 70 and the third processor 90, to which a high voltage is applied. The radiating fin 84 may have a structure in which the radiating fin 84 is integrated with the second pipe 80, or may have a structure in which the radiating fin 84 is detachable. The former case is advantageous in that radiation performance can be further improved, and the latter case is advantageous in that maintenance is easy because the radiating fin 84 can be removed and cleaned.

Instead of providing the radiating fin 84, a fan for air-cooling the second pipe 80 may be provided. The air-cooling fan has an effect of enhancing the radiation performance of the second pipe 80 as with the radiating fin 84. Alternatively, higher radiation performance may be obtained by combination of the radiating fin 84 and the air-cooling fan.

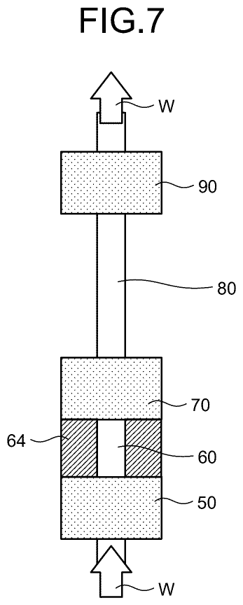

FIG. 7 is a cross-sectional view of the pulsed electric field processor according to the first embodiment, which illustrates another exemplary configuration of the pulsed electric field processor. A heat insulating material 64 is attached to the outer peripheral portion of the first pipe 60 so as to reduce performance in radiation from the object to be processed to the outside of the first pipe 60. By attaching the heat insulating material 64, it is possible to suppress a decrease in the temperature of the object to be processed in the first pipe 60, and to cause the temperature of the object to be processed to reach the appropriate temperature range when the object to be processed is located further upstream.

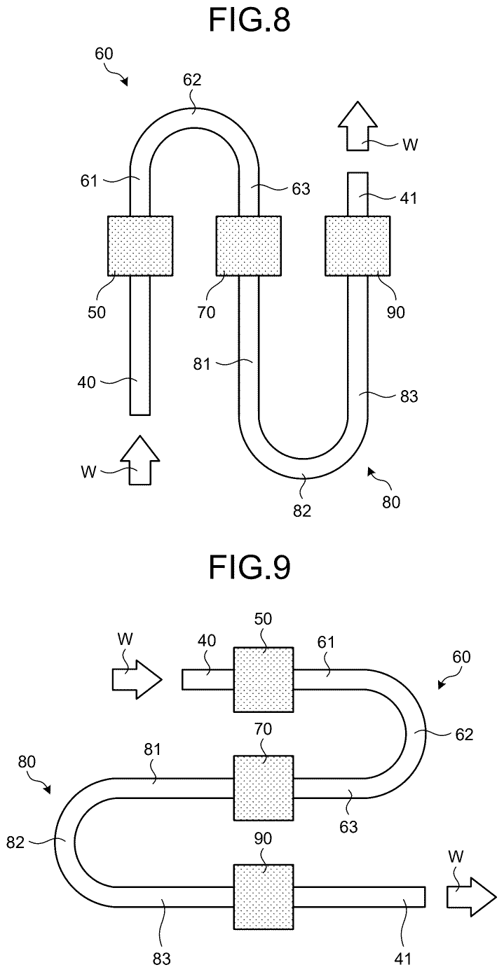

FIG. 8 is a schematic diagram illustrating still another exemplary configuration of the pulsed electric field processor according to the first embodiment. The upstream pipe 40 is installed in a vertical direction so that the object to be processed flows from a lower side to a higher side, and is connected to the first processor 50.

The first pipe 60 is a pipe connecting the first processor 50 and the second processor 70, and includes a first upstream straight portion 61, a first semicircular portion 62, and a first downstream straight portion 63. The first upstream straight portion 61 is a pipe portion that linearly connects the first processor 50 and the first semicircular portion 62. The first downstream straight portion 63 is a pipe portion connecting the first semicircular portion 62 and the second processor 70. The first semicircular portion 62 is a pipe portion having a semicircular path bent at 180 degrees through which the object to be processed passes. The first semicircular portion 62 connects the first upstream straight portion 61 and the first downstream straight portion 63.

The second pipe 80 has the same configuration as the first pipe 60, and includes a second upstream straight portion 81, a second semicircular portion 82, and a second downstream straight portion 83. The second pipe 80 connects the second processor 70 and the third processor 90.

The downstream pipe 41 is installed in the vertical direction so that the object to be processed flows from the lower side to the higher side.

With such a configuration, the constituent elements from the upstream pipe 40 to the downstream pipe 41 can be put together in a small space, so that the apparatus can be downsized. In addition, the first processor 50, the second processor 70, and the third processor 90 can be located in the vicinity of each other. This configuration is advantageous in that a wire for high voltage to be output from the pulsed power supply 10 can be shortened, leading to improvement in the safety of the apparatus.

In a case where the second pipe 80 is made longer than the first pipe 60, the sum of lengths of the second upstream straight portion 81 and the second downstream straight portion 83 is made longer than the sum of lengths of the first upstream straight portion 61 and the first downstream straight portion 63. Meanwhile, forming the first semicircular portion 62 and the second semicircular portion 82 in the same shape enables parts to be used in common, so that manufacturing cost can be reduced. Constituent elements for adjusting radiation performance, such as the radiating fin 84 and the heat insulating material 64, may be provided only in the straight portions in the first pipe 60 and the second pipe 80, or may be provided in the entire first pipe 60 and the entire second pipe 80 including the semicircular portions. In a case where the lengths of the straight portions are sufficiently longer than the lengths of the semicircular portions, the former configuration is adopted in consideration of cost-effectiveness. Meanwhile, in a case where the lengths of the straight portions are not sufficient, the latter configuration also including the semicircular portions is adopted so as to ensure radiation performance.

FIG. 9 is a schematic diagram illustrating yet another exemplary configuration of the pulsed electric field processor according to the first embodiment. In the configuration illustrated in FIG. 9, the configuration illustrated in FIG. 8 has been rotated by 90 degrees such that the upstream pipe 40 and the downstream pipe 41 extend in a horizontal direction. The upstream pipe 40, the first processor 50, and the first upstream straight portion 61 are disposed at highest positions. Next, the first downstream straight portion 63, the second processor 70, and the second upstream straight portion 81 are disposed at next highest positions. Finally, the second downstream straight portion 83, the third processor 90, and the downstream pipe 41 are disposed at lowest positions. Therefore, the average height of a path through which the object to be processed passes in the first pipe 60 is higher than the average height of the path through which the object to be processed passes in the second pipe 80. Between the upstream pipe 40 and the downstream pipe 41, a high temperature portion is located at a lower position, and a low temperature portion is located at a higher position. As a result, for example, heat released to the outside from the second downstream straight portion 83 rises to a higher position by natural convection. It is thus possible to increase the temperature of the outside of the first upstream straight portion 61, and to improve thermal insulation performance of the first pipe 60.

Different power may be output from the pulsed power supply 10 to the first processor 50, the second processor 70, and the third processor 90. Since it is desirable to further suppress a temperature rise as proceeding downstream, less power is supplied to a processor located further downstream. That is, largest power is supplied to the first processor 50, second largest power is supplied to the second processor 70, and smallest power is supplied to the third processor 90.

Regarding the adjustment of power in each processor, it is desirable to adjust a pulse width or a pulse frequency while keeping the pulse voltage constant, so as to simplify power supply control. Alternatively, all the pulse voltage, the pulse width, and the pulse frequency may be constant, and the areas of the electrodes 51 provided in the processors may be different. Since the larger the area of the electrode 51, the larger a pulse current flows, it is possible to prevent a temperature rise on the downstream side by reducing the area of the electrode 51 in a processor located further downstream. That is, the area of the electrode 51 of the first processor 50 is made the largest, the area of the electrode 51 of the second processor 70 is made the second largest, and the area of the electrode 51 of the third processor 90 is made the smallest.

As described above, according to the first embodiment, the radiation performance of the second pipe 80 is made higher than the radiation performance of the first pipe 60. Therefore, the first processor 50, the second processor 70, and the third processor 90 are not structurally restricted for heat radiation, and the object to be processed can be processed at an appropriate temperature. Therefore, it is possible to implement a pulsed electric field processor that has a simple structure and can be downsized while improving the quality of the object to be processed.

Note that a plurality of control methods has been described above, including: the flow distance of the object to be processed is made longer in the second pipe 80 than in the first pipe 60; radiation performance per distance to be covered by the object to be processed is made higher in the second pipe 80 than in the first pipe 60; the wall thickness of the second pipe 80 is made smaller than the wall thickness of the first pipe 60; the thermal conductivity of a material included in the second pipe 80 is made higher than the thermal conductivity of a material included in the first pipe 60; the heat radiation area of the second pipe 80 is made larger than the heat radiation area of the first pipe 60; the heat insulating material 64 is provided on the outer peripheral portion of the first pipe 60; the average height of the object to be processed in the first pipe 60 is made higher than the average height of the object to be processed in the second pipe 80; the area of the electrode of the first processor 50 is made larger than the area of the electrode of the second processor 70; and power for the pulsed electric field processing to be supplied to the first processor 50 is made larger than power for the pulsed electric field processing to be supplied to the second processor 70. Meanwhile, two or more of the plurality of control methods may be appropriately selected, and the selected two or more control methods may be performed in combination.

### Second Embodiment

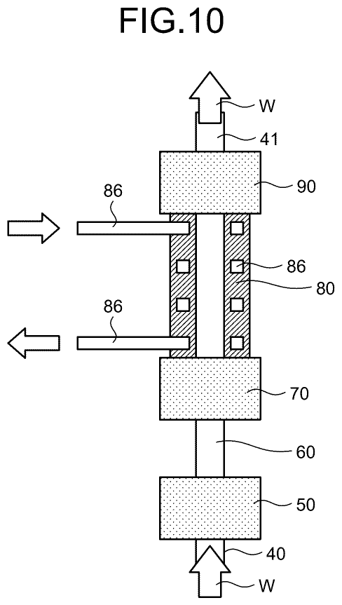

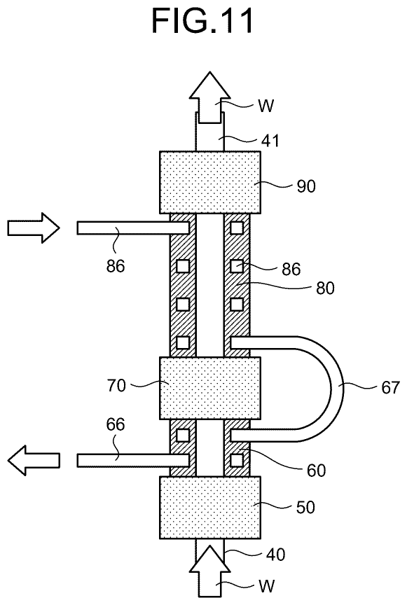

FIG. 10 is a cross-sectional view of a pulsed electric field processor according to a second embodiment, which illustrates an exemplary configuration of the pulsed electric field processor. In the second embodiment, a cooling channel 86 is provided as a cooler in the second pipe 80. Other constituent elements than the cooling channel 86 are the same as those in the first embodiment, and redundant description will be omitted.

As illustrated in FIG. 10, the cooling channel 86 is provided in the second pipe 80. The cooling channel 86 is a first channel through which a refrigerant for lowering the temperature of an object to be processed flows. It is possible to obtain higher radiation performance by providing the cooling channel 86. In a case where the cooling channel 86 is provided so as to water-cool the object to be processed, radiation performance is represented by heat flux from the object to be processed passing through the inside of the second pipe 80 to the refrigerant. Therefore, it is possible to enhance radiation performance by, for example: increasing the thermal conductivity of the material included in the second pipe 80; increasing the temperature or flow rate of the refrigerant; and increasing the area of contact between the refrigerant and the second pipe 80.

Therefore, it is possible to adjust radiation performance by adjusting the temperature or flow rate of the refrigerant. Thus, it is possible to perform feedback control so as to achieve a target temperature by measuring the temperature of the object to be processed. Alternatively, it is also possible to perform feedforward control in such a way as to adjust the temperature or flow rate of the refrigerant according to output power of the pulsed power supply 10. Both the feedback control and the feedforward control have an effect of accurately adjusting temperature.

FIG. 11 is a cross-sectional view of the pulsed electric field processor according to the second embodiment, which illustrates another exemplary configuration of the pulsed electric field processor. A heating channel 66 and a connection channel 67 have been added to the configuration illustrated in FIG. 10 to obtain the configuration illustrated in FIG. 11. The heating channel 66 is provided in the first pipe 60. The heating channel 66 is a second channel through which a refrigerant for raising the temperature of the object to be processed flows. In addition, the connection channel 67 is provided so as to connect the heating channel 66 and the cooling channel 86. It is possible to cause the refrigerant that has increased in temperature in the cooling channel 86 to flow into the heating channel 66. Therefore, heat energy taken from the object to be processed in the second pipe 80 can be used for increasing the temperature of the object to be processed in the first pipe 60. With such a configuration, energy can be effectively used to achieve an energy-saving effect. Furthermore, it is possible to achieve a higher energy-saving effect by shortening the length of the connection channel 67 and performing heat insulation.

As described above, according to the second embodiment, the temperature of the object to be processed can be more appropriately managed. Thus, the quality of the object to be processed is improved. Furthermore, since the heating channel 66 and the cooling channel 86 are connected to each other, an energy-saving effect can be expected.

Note that the control method of the second embodiment may be appropriately performed in combination with the plurality of control methods described in the first embodiment.

The configurations set forth in the above embodiments show examples of the subject matter of the present disclosure, and it is possible to combine the configurations with another known technique, and is also possible to partially omit or change the configurations without departing from the scope of the present disclosure.

### REFERENCE SIGNS LIST

10 pulsed power supply; 11, 12 capacitor; 13, 14 switch; 15 direct-current power supply; 16 current limiter; 40 upstream pipe; 41 downstream pipe; 50 first processor; 51 electrode; 52 high-voltage electrode; 53 low-voltage electrode; 54 insulating material; 55 processing chamber ; 60 first pipe; 64 heat insulating material; 66 heating channel; 67 connection channel; 70 second processor; 80 second pipe; 84 radiating fin; 86 cooling channel; 90 third processor.

1. A pulsed electric field processor comprising:
a first processor configured to perform first processing on an object to be processed, the first processing being pulsed electric field processing, the object to be processed being in liquid form;
a first pipe through which the object to be processed having passed through the first processor passes;
a second processor configured to perform second processing on the object to be processed, the second processing including the pulsed electric field processing, the object to be processed having passed through the first pipe flows into the second processor;
a second pipe through which the object to be processed having passed through the second processor passes; and
a third processor configured to perform third processing on the object to be processed, the third processing including the pulsed electric field processing, the object to be processed having passed through the second pipe passes through the third processor, wherein
radiation performance of the second pipe is higher than radiation performance of the first pipe.

2. The pulsed electric field processor according to claim 1, wherein
a flow distance of the object to be processed is longer in the second pipe than in the first pipe.

3. The pulsed electric field processor according to claim 1, wherein
radiation performance per passing distance of the second pipe is higher than radiation performance per passing distance of the first pipe.

4. The pulsed electric field processor according to claim 1, wherein
a wall thickness of the second pipe is smaller than a wall thickness of the first pipe.

5. The pulsed electric field processor according to claim 1, wherein
a thermal conductivity of a material included in the second pipe is higher than a thermal conductivity of a material included in the first pipe.

6. The pulsed electric field processor according to claim 1, wherein
a heat radiation area of the second pipe is larger than a heat radiation area of the first pipe.

7. The pulsed electric field processor according to claim 1, wherein
a heat insulating material is provided on an outer peripheral portion of the first pipe.

8. The pulsed electric field processor according to claim 1, wherein
an average height of the object to be processed in the first pipe is higher than an average height of the object to be processed in the second pipe.

9. The pulsed electric field processor according to claim 1, wherein
the first processor and the second processor each includes an electrode for performing the pulsed electric field processing, and
an area of the electrode of the first processor is larger than an area of the electrode of the second processor.

10. The pulsed electric field processor according to claim 1, wherein
power for the pulsed electric field processing to be supplied to the first processor is larger than power for the pulsed electric field processing to be supplied to the second processor.

11. The pulsed electric field processor according to claim 1, comprising
a cooler configured to cool the second pipe.

12. The pulsed electric field processor according to claim 1, wherein
the first pipe and the second pipe include a second channel and a first channel, respectively, the first channel and the second channel are configured to adjust temperature, and
the first channel and the second channel are connected.
